(19) United States
(12) Patent Application Publication
(10) Pub. No.: US 2025/0160569 A1
(43) Pub. Date: May 22, 2025

(54) MULTIPURPOSE OVEN

(71) Applicant: SHINERICH INDUSTRIAL LTD., Shenzhen (CN)

(72) Inventor: Weidong JIN, Shenzhen (CN)

(73) Assignee: SHINERICH INDUSTRIAL LTD., Shenzhen (CN)

(21) Appl. No.: 18/422,320

(22) Filed: Jan. 25, 2024

(30) Foreign Application Priority Data
Nov. 22, 2023 (CN) 202323170628.X

(51) Int. Cl. A47J 37/07

(52) U.S. Cl. CPC A47J 37/0786; A47J 37/0704; A47J 37/0731

(57) ABSTRACT

Disclosed is a multipurpose oven including a base, a basin body and a charcoal tray. The basin body is provided on the base and is supported by the base, the basin body is configured for burning wood, and the charcoal tray is detachably provided in the basin body and is configured for holding charcoal. When the user needs to burn wood, the charcoal tray is removed from the basin body, and the wood is placed in the basin body and being ignited; at this time, the multipurpose oven can be configured as a stove. When the user needs to burn charcoal, the charcoal tray is installed in the basin body, and the charcoal is placed in the charcoal tray for burning; at this time, the multipurpose oven can be configured as a charcoal stove.

### CROSS-REFERENCE TO RELATED APPLICATIONS

The present application claims priority to Chinese Patent Application No. 202323170628.X, filed on Nov. 22, 2023. The disclosure of the above-mentioned application is incorporated herein by reference in its entirety.

### TECHNICAL FIELD

The present application relates to the technical field of cooking equipment, in particular to a multipurpose oven.

### BACKGROUND

Currently, the ovens on the market are generally divided into two types: stoves and charcoal stoves, stoves generally only burn wood, and charcoal stoves are generally only suitable for burning charcoal. When users use wood for heating, they usually choose a stove suitable for wood burning, however, when using the stove, the burning of wood in the stove will produce smoke and dust, which is not suitable for barbecue, thus, in the scenario where the user uses charcoal for barbecue, a charcoal stove needs to be used to hold the charcoal. In summary, the versatility of stoves and charcoal stoves is poor, the stoves and the charcoal stoves cannot handle both wood combustion and charcoal combustion, resulting in limited use scenarios.

### SUMMARY

The main purpose of the present application is to provide a multipurpose oven, which aims to solve the problem that ordinary ovens cannot handle both wood burning and charcoal burning.

In order to achieve the above purpose, the multipurpose oven proposed by the present application includes: a base; a basin body configured for burning wood, and the basin body is provided on the base; a charcoal tray configured for burning charcoal, and the charcoal tray is detachably provided in the basin body; and in response to that it is necessary to burn wood, the charcoal tray is removed from the basin body, and the wood is placed in the basin body for burning; in response to that it is necessary to burn charcoal, the charcoal tray is installed in the basin body, and the charcoal is placed in the charcoal tray for burning.

In an embodiment, the multipurpose oven further includes a bracket, the bracket is fixedly connected to the basin body, and the charcoal tray is installed on the bracket.

In an embodiment, the bracket includes a connecting piece and a plurality of supporting pieces, and the plurality of the supporting pieces are respectively connected to the connecting piece; one end of each support piece is plugged into the basin body, and the other end of each support piece is configured to support the charcoal tray.

In an embodiment, the charcoal tray includes a retaining ring and a base plate, the retaining ring is provided around an edge of the base plate, and a plurality of through holes are provided on the base plate.

In an embodiment, the multipurpose oven further includes a first grilling net and a second grilling net, the first grilling net is provided above the basin body, and the second grilling net is provided at a side of the first grilling net away from the basin body.

In an embodiment, the multipurpose oven further includes an adjustment assembly, the adjustment assembly includes a first sleeve located on the basin body and a first lifting column connected to the first grilling net, the first lifting column is movably provided in the first sleeve, so that the first grilling net is configured to move along an axis direction of the first lifting column and rotate around an axis of the first lifting column.

In an embodiment, the adjustment assembly further includes a second sleeve located on the basin body and a second lifting column connected to the second grilling net, the second lifting column is movably provided in the second sleeve, so that the second grilling net is configured to move along an axis direction of the second lifting column and rotate around an axis of the second lifting column.

In an embodiment, the adjustment assembly further includes positioning pins, a plurality of first pin holes are provided through the first lifting column for inserting the positioning pins, and the positioning pins are inserted into the different first pin holes to adjust a height of the first grilling net; and/or a plurality of second pin holes are provided through the second lifting column for inserting the positioning pins, and the positioning pins are inserted into the different second pin holes to adjust a height of the second grilling net.

In an embodiment, the base includes a fixing frame and a plurality of supporting feet, one end of the plurality of the supporting feet is connected to the basin body respectively, and the fixing frame is fixedly connected to the plurality of the supporting feet.

In an embodiment, the multipurpose oven further includes a plurality of table plates, the plurality of the table plates are connected in sequence along an edge of the basin body, and the basin body and the plurality of the table plates are all provided with air holes.

The technical solution of the present application is to add a charcoal tray in the basin body of the oven, so that the oven can take into account the use scenarios of burning wood and charcoal. The multipurpose oven includes a base, a basin body and a charcoal tray. The basin body is provided on the base and is supported by the base, and the basin body is configured for wood burning. The charcoal tray is detachably provided in the basin body and is configured to hold charcoal. When the user needs to burn wood, the charcoal tray is removed from the basin body, the wood is placed in the basin body and being ignited, at this time, the multipurpose oven can be configured as a stove. When the user needs to burn charcoal, the charcoal tray is installed in the basin body, and the charcoal is placed in the charcoal tray for burning, at this time, the multipurpose oven can be configured as a charcoal stove. Compared with the conventional stove or charcoal stove, the multipurpose oven proposed in this plan can burn both wood and charcoal, which has multiple uses at the same time, and the usage scenarios are not limited, thereby improving the practicality of the product.

### BRIEF DESCRIPTION OF THE DRAWINGS

In order to explain the embodiments of the present application or the technical solutions in the existing technology more clearly, the accompanying drawings needed to be used in the description of the embodiments or the existing technology will be briefly introduced below. Obviously, the accompanying drawings in the following description are only some embodiments of the present application, other accompanying drawings can be obtained based on the provided accompanying drawings without exerting creative efforts for those of ordinary skill in the art.

FIG. 1 is a structural schematic view of a multipurpose oven according to an embodiment of the present application.

FIG. 2 is a structural schematic view of some components of the multipurpose oven according to an embodiment of the present application.

FIG. 3 is a partial structural schematic view of a position pointed by arrow A in FIG. 1.

FIG. 4 is a partial structural schematic view of a position pointed by arrow B in FIG. 1.

The realization of the purpose, functional features and advantages of the present application will be further described in conjunction with the embodiments and with reference to the accompanying drawings.

### DETAILED DESCRIPTION OF THE EMBODIMENTS

The technical solutions in the embodiments according to the present application will be clearly and completely described below in conjunction with the accompanying drawings in the embodiments according to the present application, and it is clear that the described embodiments are only a part of the embodiments according to the present application, and not all of the embodiments. Based on the embodiments in the present application, all other embodiments obtained by those of ordinary skill in the art without making creative labor fall within the scope of the present application.

It should be noted that in the embodiment of the present application, all directional indications (such as up, down, left, right, front, back or the like) are only used to explain the relative positional relationship, movement and so on between various components in a specific posture (as shown in the accompanying drawings). If the specific posture changes, the directional indication will also change accordingly.

In addition, if there are descriptions involving “first”, “second” or the like, the descriptions of “first”, “second” or the like are only for descriptive purposes and cannot be understood as indicating or implying the relative importance or implicitly indicating the quantity of the technical features indicated. Therefore, features defined as “first” and “second” may explicitly or implicitly include at least one of these features. In addition, the technical solutions of various embodiments can be combined with each other, but it must be based on that those of ordinary skill in the art can realize. When the combination of technical solutions is contradictory or cannot be realized, it should be considered that such combination of technical solutions does not exist and is not within the protection scope claimed by the present application.

The present application proposes a multipurpose oven.

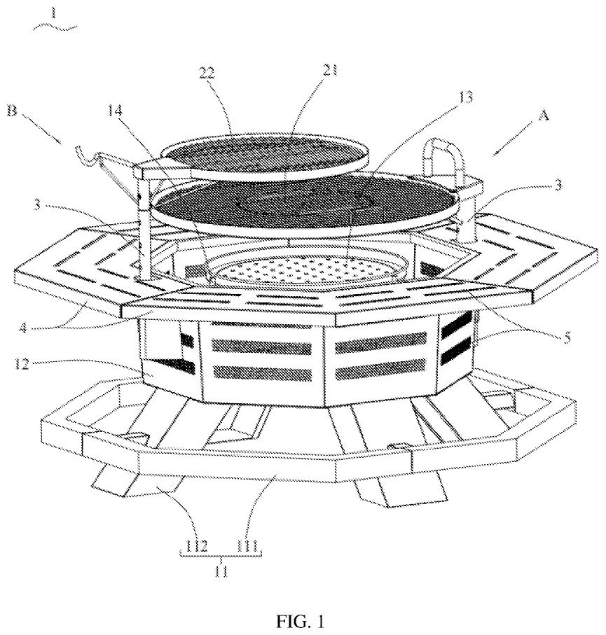

As shown in FIG. 1, the multipurpose oven 1 includes a base 11, a basin body 12 and a charcoal tray 13. The basin body 12 is hexagonal and is provided on the base 11 and is supported by the base 11, and the basin body 12 is configured for wood burning. The charcoal tray 13 is detachably provided in the basin body 12 and is configured to hold charcoal. When the user needs to burn wood, the charcoal tray 13 is removed from the basin body 12, the wood is placed in the basin body 12 and is ignited, at this time, the multipurpose oven 1 can be configured as a stove. When the user needs to burn charcoal, the charcoal tray 13 is installed in the basin body 12, and the charcoal is placed in the charcoal tray 13 for burning, at this time, the multipurpose oven 1 can be configured as a charcoal stove. Compared with the conventional stove or charcoal stove, the multipurpose oven 1 proposed in this plan can burn both wood and charcoal, which has multiple uses at the same time, and the usage scenarios are not limited, thereby improving the practicality of the product.

In an embodiment, the multipurpose oven 1 further includes a bracket 14, the bracket 14 is fixedly connected to the basin body 12, and the charcoal tray 13 is installed on the bracket 14.

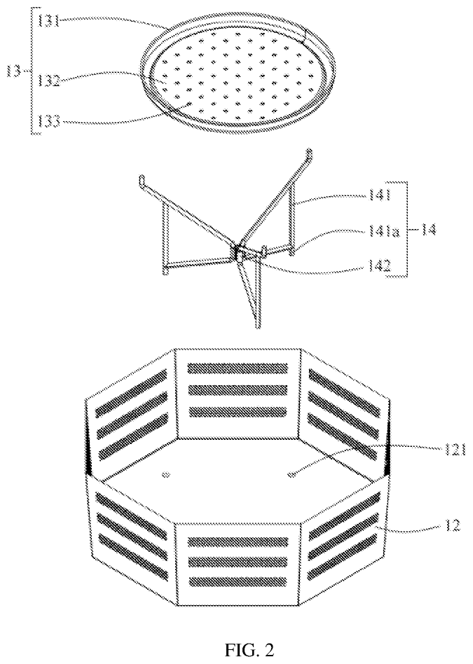

As shown in FIG. 2, in an embodiment of the present application, the multipurpose oven 1 further includes a bracket 14 provided in the basin body 12, the bracket 14 is fixedly connected to the basin body 12, and the charcoal tray 13 is installed horizontally on the bracket 14, so that the charcoal tray 13 is located at the upper opening of the basin body 12 to facilitate the user to utilize the heat generated by charcoal combustion. For example, when the user uses charcoal for barbecue, the charcoal placed in the charcoal tray 13 is first ignited, and when the open flame of the charcoal subsides and is in red-hot state, the heat radiated outward is used for barbecue. Therefore, the closer to the charcoal tray 13, the higher the temperature. If the charcoal tray 13 is placed in the middle of the basin body 12 or the bottom of the basin body 12 and is far away from the opening, the temperature will be relatively low, the heating efficiency will be low, and the space inside the basin body 12 will be limited, which is not conducive to personnel operation. Therefore, it is very necessary to add a bracket 14 to the basin body 12.

In an embodiment, the bracket 14 includes a connecting piece 142 and a plurality of supporting pieces 141, and the plurality of the supporting pieces 141 are respectively connected to the connecting piece 142, One end of each support piece 141 is plugged into the basin body 12, and the other end of each support piece 141 is configured to support the charcoal tray 13.

As shown in FIG. 2, in an embodiment of the present application, the bracket 14 includes a connecting piece 142 and three supporting pieces 141. The supporting piece 141 is formed into a triangle by metal wires, and each supporting piece 141 is connected to the connecting piece 142. The supporting piece 141 is provided with a plug 141a at one end close to the basin body 12, and three mounting holes 121 are provided through the bottom of the basin body 12. Each plug 141a is inserted into its corresponding mounting hole 121 to fix the entire bracket 14 on the basin body 12. One end of the three supporting pieces 141 away from the plug 141a form a circular installation position. The charcoal tray 13 is also provided in a circular shape, the diameter of the charcoal tray 13 matches the installation position, and the charcoal tray 13 is placed on the bracket 14 and is supported by three supporting pieces 141. When the user uses wood for heating, he just needs to remove the charcoal tray 13 and bracket 14. The bracket 14 has a simple structure and is easy to disassemble and assemble.

It should be noted that in the above embodiment, the number of supporting pieces 141 is three, and the shape is triangular. In some other embodiments of the present application, the supporting piece 141 can also be in a rectangular or other shape, and the charcoal tray 13 can also be in a square or hexagonal shape. The number of supporting pieces 141 can also be provided correspondingly according to the shape of the charcoal tray 13, as long as the charcoal tray 13 can be supported in the basin body 12, which is not limited here.

In an embodiment, the charcoal tray 13 includes a retaining ring 131 and a base plate 132, the retaining ring 131 is provided around an edge of the base plate 132, and a plurality of through holes 133 are provided on the base plate 132.

As shown in FIG. 2, in order to facilitate the burning of charcoal, in an embodiment of the present application, the charcoal tray 13 includes a retaining ring 131 and a base plate 132. The edge of the base plate 132 is turned upward to form the retaining ring 131 to prevent the charcoal on the charcoal tray 13 from falling into the bottom of the basin body 12 from the edge; charcoal combustion requires air, and the base plate 132 is provided with a plurality of evenly arranged circular through holes 133. When the charcoal on the base plate 132 is burned, the air in the basin body 12 enters the upper part from the lower part of the base plate 132 via the through hole 133, allowing the charcoal to continue burning for heating. It should be noted that, the retaining ring 131 and the base plate 132 can be provided separately or formed in one piece, and there are no restrictions on the number, shape and arrangement of through holes 133 on the base plate 132.

In an embodiment, the multipurpose oven further includes a first grilling net 21 and a second grilling net 22, the first grilling net 21 is provided above the basin body 12, and the second grilling net 22 is provided at a side of the first grilling net 21 away from the basin body 12.

As shown in FIG. 1, in order to facilitate users to barbecue, in an embodiment of the present application, a first grilling net 21 and a second grilling net 22 are further provided above the basin body 12. The second grilling net 22 is located on the side of the first grilling net 21 away from the basin body 12, and the area of the first grilling net 21 is approximately the same as the cross-sectional area of the opening of the basin body 12, so that it can make maximum use of the heat radiated by the charcoal in the charcoal tray 13. Therefore, the first grilling net 21 can be used to heat meat and other ingredients. The second grilling net 22 has a relatively small area and is located above the first grilling net 21 and is relatively far away from the charcoal tray 13, so that it can utilize less heat and therefore has a relatively low temperature. This layer of grilling net can be used to keep food warm. In summary, setting up a two-layer grilling net has both heating effect and heat preservation effect, thereby improving the user's usage experience.

In an embodiment, the multipurpose oven further includes an adjustment assembly 3, and the adjustment assembly 3 includes a first sleeve 31 located on the basin body 12 and a first lifting column 32 connected to the first grilling net 21. The first lifting column 32 is movably provided in the first sleeve 31, so that the first grilling net 21 is configured to move along an axis direction of the first lifting column 32 and rotate around an axis of the first lifting column 32.

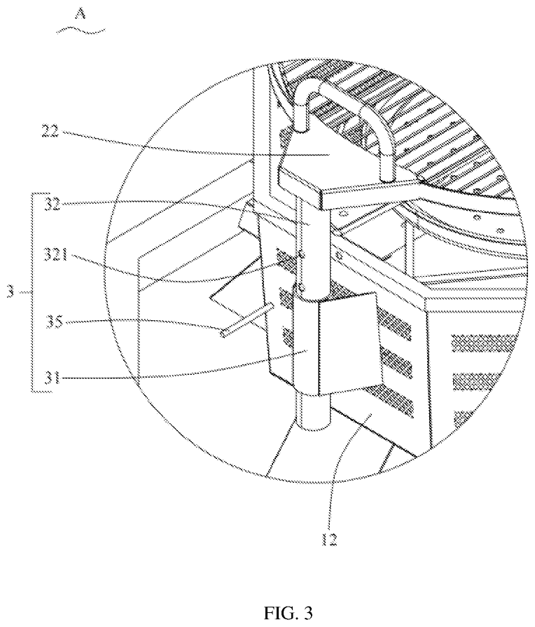

As shown in FIG. 1, with further reference to FIG. 3, in an embodiment of the present application, the multipurpose oven 1 further includes an adjustment assembly 3 for adjusting the height and angle of the grilling net. Specifically, the adjustment assembly 3 includes a first sleeve 31 and a first lifting column 32, the first sleeve 31 is a tubular shape with openings at both ends, both sides are vertically welded to the outer side wall of the basin body 12 via fixing plate. The diameter of the first lifting column 32 is slightly smaller than the inner diameter of the first sleeve 31. One end of the first lifting column 32 is fixedly connected to the first grilling net 21, another end of the first lifting column 32 extends into the first sleeve 31 and can move and rotate freely along the axis direction of the first sleeve 31. Therefore, the first grilling net 21 can move up and down along with the first lifting column 32 to adjust the distance from the charcoal tray 13, at the same time, the first grilling net 21 can also rotate around the axis of the first lifting column 32 to keep it away from the charcoal tray 13, which is convenient for users to place ingredients or adjust charcoal fire.

It should be noted that in the above embodiment, the first sleeve 31 is welded to the basin body 12 via the fixing plate. In some other embodiments of the present application, the first sleeve 31 can also be directly welded to the basin body 12, or connected to the basin body 12 by the means of bolts or the like, which is not limited here.

In an embodiment, the adjustment assembly 3 further includes a second sleeve 33 located on the basin body 12 and a second lifting column 34 connected to the second grilling net 22. The second lifting column 34 is movably provided in the second sleeve 33, so that the second grilling net 22 is configured to move along an axis direction of the second lifting column 34 and rotate around an axis of the second lifting column 34.

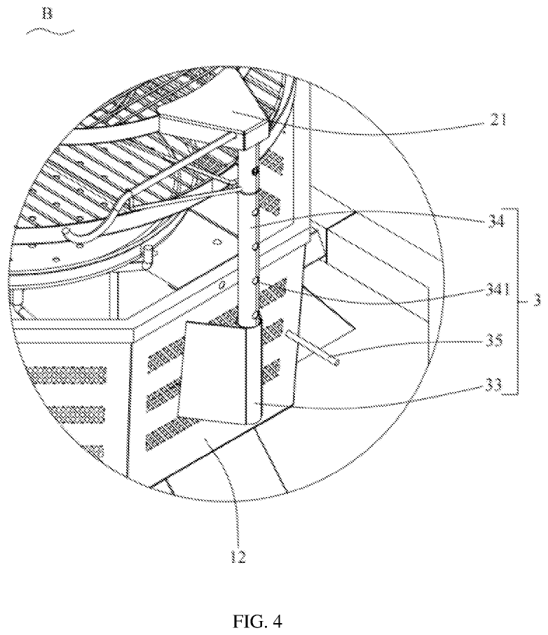

As shown in FIG. 1, with further reference to FIG. 4, in an embodiment of the present application, the adjustment assembly 3 further includes a second sleeve 33 and a second lifting column 34, specifically, the second sleeve 33 and the second lifting column 34 have the same matching structure as the first sleeve 31 and the first lifting column 32, the second sleeve 33 is fixed on the outer side wall of the basin body 12 opposite to the first sleeve 31. Since the structure is the same, the second grilling net 22 can move up and down in the second sleeve 33 along with the second lifting column 34 and adjust the distance from the first grilling net 21, at the same time, the second grilling net 22 can also rotate around the axis of the second lifting column 34 to keep it away from the charcoal tray 13, which is convenient for users to process the ingredients on the first grilling net 21.

In an embodiment, the adjustment assembly 3 further includes positioning pins 35, a plurality of first pin holes 321 are provided through the first lifting column 32 for inserting the positioning pins 35, and the positioning pins 35 are inserted into the different first pin holes 321 to adjust a height of the first grilling net 21; and/or a plurality of second pin holes 341 are provided through the second lifting column 34 for inserting the positioning pins 35, and the positioning pins 35 are inserted into the different second pin holes 341 to adjust a height of the second grilling net 22.

As shown in FIG. 3 and FIG. 4, in order to adjust the height of the grilling net, in an embodiment of the present application, the adjustment assembly 3 further includes a positioning pin 35, and a plurality of the first pin holes 321 are provided through the first lifting column 32. A plurality of the first pin holes 321 are arranged along the length direction of the first lifting column 32, and the positioning pin 35 is inserted into the first pin hole 321. The first lifting column 32 moves downward due to the action of gravity, and the positioning pin 35 located in the first pin hole 321 is stuck above the first sleeve 31 to prevent the first lifting column 32 from continuing to move downward to achieve fixation. Inserting the positioning pin 35 into different first pin hole 321 can adjust the distance between the first grilling net 21 and the charcoal tray 13. When rotating the first grilling net 21, as long as the friction between the positioning pin 35 and the first sleeve 31 is overcome, the first lifting column 32 can drive the positioning pin 35 to rotate together. The second lifting column 34 is also provided with a plurality of the second pin holes 341, and the height adjustment and angle rotation of the second grilling net 22 are achieved by inserting the positioning pin 35.

In an embodiment, the base 11 includes a fixing frame 111 and a plurality of supporting feet 112. One end of the plurality of the supporting feet 112 is connected to the basin body 12 respectively, and the fixing frame 111 is fixedly connected to the plurality of the supporting feet 112.

As shown in FIG. 1, in an embodiment of the present application, the base 11 includes four supporting feet 112 and a hexagonal fixing frame 111, and the upper end of the supporting feet 112 is connected to the bottom of the basin body 12 via screws. The fixing frame 111 is provided around the supporting feet 112, and the fixing frame 111 is fixedly connected with the supporting feet 112 via screws to improve the stability of the supporting feet 112.

In an embodiment, the multipurpose oven 1 further includes a plurality of table plates 4, the plurality of the table plates 4 are connected in sequence along an edge of the basin body 12, and the basin body 12 and the plurality of the table plates 4 are all provided with air holes 5.

As shown in FIG. 1, in an embodiment of the present application, the edge of the upper end of the basin body 12 is connected with four table plates 4 in sequence via screws for the user to place barbecue supplies or ingredients, and the elongated air hole 5 are provided through all the table plates 4 and the basin body 12 to allow smooth air circulation. It should be noted that the air hole 5 can be provided in different patterns to enhance the aesthetics of the multipurpose oven 1.

The present application provides a multipurpose oven 1 including a base 11, a basin body 12 and a charcoal tray 13. The basin body 12 is hexagonal and is provided on the base 11. The base 11 is four supporting feet 112 and each supporting foot 112 is connected to the bottom of the basin body 12, and the four supporting feet 112 are all connected with the fixing frame 111 to improve the stability of the supporting feet 112; a bracket 14 is plugged into the basin body 12, and the bracket 14 includes three supporting pieces 141 and a connecting piece 142; each supporting piece 141 is connected to the connecting piece 142, and a plug 141a is provided below the supporting piece 141; a mounting hole 121 is provided through the bottom of the basin body 12, and the plug 141a is inserted into the mounting hole 121 to fix the bracket 14 in the basin body 12; the charcoal tray 13 is installed on the bracket 14 for holding charcoal. When the user needs to burn wood, the charcoal tray 13 and bracket 14 are removed from the basin body 12; when the user needs to burn charcoal, the charcoal tray 13 is installed in the basin body 12 by the bracket 14, and the charcoal is placed in the charcoal tray 13 for burning; the first grilling net 21 is provided above the basin body 12, and the second grilling net 22 is provided above the first grilling net 21; a first sleeve 31 is fixed on the outer side wall of the basin body 12, a first grilling net 21 is connected to a first lifting column 32, and a plurality of the pin holes 321 are provided through the first lifting column 32. The first lifting column 32 is inserted into the first sleeve 31, and the positioning pin 35 is used to insert the first pin hole 321 to snap the first sleeve 31 to adjust the distance between the first grilling net 21 and the charcoal tray 13; the first grilling net 21 can drive the first lifting column 32 to rotate in the first sleeve 31; the outer side wall of the basin body 12 is also provided with a second sleeve 33, and the second grilling net 22 is connected with a second lifting column 34; a plurality of second pin holes 341 pass through the second lifting column 34. The second positioning pin 35 is used to insert the second pin hole 341 to snap the second sleeve 33 to adjust the distance between the second grilling net 22 and the first grilling net 21, and the second grilling net 22 can drive the second lifting column 34 to rotate in the second sleeve 33; four table plates are connected to the edge of the basin body 12 in sequence, and the elongated air hole 5 passes through all the table plates 4 and the basin body 12 to allow smooth air circulation.

The above are only some embodiments of the present application, and are not intended to limit the scope of the present application. Under the concept of the present application, any equivalent structure transformation made by using the description and accompanying drawings of the present application, or directly or indirectly applied in other related technical fields, is included within the scope of the present application.

What is claimed is:

1. A multipurpose oven, comprising:
a base;
a basin body configured for burning wood, wherein the basin body is provided on the base; and
a charcoal tray configured for burning charcoal, wherein the charcoal tray is detachably provided in the basin body;
wherein, in response to that it is necessary to burn wood, the charcoal tray is removed from the basin body, and the wood is placed in the basin body for burning; in response to that it is necessary to burn charcoal, the charcoal tray is installed in the basin body, and the charcoal is placed in the charcoal tray for burning.

2. The multipurpose oven according to claim 1, further comprising:
a bracket;
wherein the bracket is fixedly connected to the basin body, and the charcoal tray is installed on the bracket.

3. The multipurpose oven according to claim 2, wherein the bracket comprises a connecting piece and a plurality of supporting pieces, and the plurality of the supporting pieces are respectively connected to the connecting piece; one end of each support piece is plugged into the basin body, and the other end of each support piece is configured to support the charcoal tray.

4. The multipurpose oven according to claim 1, wherein the charcoal tray comprises a retaining ring and a base plate, the retaining ring is provided around an edge of the base plate, and a plurality of through holes are provided on the base plate.

5. The multipurpose oven according to claim 1, further comprising:
a first grilling net; and
a second grilling net;
wherein the first grilling net is provided above the basin body, and the second grilling net is provided at a side of the first grilling net away from the basin body.

6. The multipurpose oven according to claim 5, further comprising:
an adjustment assembly;
wherein the adjustment assembly comprises a first sleeve located on the basin body and a first lifting column connected to the first grilling net; the first lifting column is movably provided in the first sleeve, so that the first grilling net is configured to move along an axis direction of the first lifting column and rotate around an axis of the first lifting column.

7. The multipurpose oven according to claim 6, wherein the adjustment assembly further comprises a second sleeve located on the basin body and a second lifting column connected to the second grilling net; the second lifting column is movably provided in the second sleeve, so that the second grilling net is configured to move along an axis direction of the second lifting column and rotate around an axis of the second lifting column.

8. The multipurpose oven according to claim 7, wherein the adjustment assembly further comprises positioning pins, a plurality of first pin holes are provided through the first lifting column for inserting the positioning pins, and the positioning pins are inserted into the different first pin holes to adjust a height of the first grilling net; and/or
a plurality of second pin holes are provided through the second lifting column for inserting the positioning pins, and the positioning pins are inserted into the different second pin holes to adjust a height of the second grilling net.

9. The multipurpose oven according to claim 1, wherein the base comprises a fixing frame and a plurality of supporting feet, one end of the plurality of the supporting feet is connected to the basin body respectively, and the fixing frame is fixedly connected to the plurality of the supporting feet.

10. The multipurpose oven according to claim 1, further comprising:
a plurality of table plates;
wherein the plurality of the table plates are connected in sequence along an edge of the basin body, and the basin body and the plurality of the table plates are all provided with air holes.
